(19) United States
(12) Patent Application Publication
(10) Pub. No.: US 2024/0017979 A1
(43) Pub. Date: Jan. 18, 2024

(54) CAP LIFTER

(71) Applicant: DAZL INCEPTION INC., St. George (CA)

(72) Inventors: Laura Bosch, St. George (CA); Arron Bosch, St. George (CA)

(21) Appl. No.: 18/266,918

(22) PCT Filed: Dec. 14, 2021
(86) PCT No.: PCT/CA2021/051808

§ 371 Date: Jun. 13, 2023

Related U.S. Application Data
(60) Provisional application No. 63/125,037, filed on Dec. 14, 2020.

(51) Int. Cl. B67B 7/16

(52) U.S. Cl. CPC B67B 7/16

(57) ABSTRACT

A portable lifting apparatus, including a gripping portion and a lifting portion secured to the gripping portion and extending along a lifting portion longitudinal axis between a lifting portion forward end and a lifting portion rearward end, the lifting portion including a wedge portion having a pair of arm members laterally spaced about the lifting portion longitudinal axis to provide an inner space between, the pair of arm members extending apart at an acute angle and with an arm spacing between, the arm spacing increasing towards the lifting portion forward end, each arm member having an arm inward face facing the inner space, each arm inward face including an upwardly directed arm prying surface, and a backing portion defining a downwardly directed support surface extending over each of the pair of arm prying surfaces, and spaced from each of the pair of arm prying surfaces by a clearance distance.

### TECHNICAL FIELD

The disclosure relates to opening containers, and particularly to a cap lifting apparatus and method

### BACKGROUND

U.S. Pat. No. 2,759,383 to Mrazik purports to disclose a tool for the removal of a seal cap covering an outwardly projecting flanged opening and plug type closure for a container where the seal cap has a skirt portion formed about an outer circumferential bead on said outwardly projecting flange, comprising an elongated handle having at one end thereof an outwardly opening U-shaped member including an arcuate heel joining a pair of projecting yieldable arms for reception of the seal cap between the projecting arms thereof, said U-shaped member having an inwardly projecting lip extending around the bottom inner margin of said arcuate heel and a substantial distance along the bottom inner margins of said projecting arms for engagement with a side portion of the seal cap skirt for upward forcing thereof about and beyond said bead, said projecting arms being adapted to yield laterally to permit said arms to diverge slightly and also pass about and beyond said bead while continuously engaging the skirt portion of said seal cap.

U.S. Pat. No. 3,126,771 to Feiler purports to disclose a combination tool for lifting various sizes of caps and lids from containers comprising a longitudinal handle lever, a laterally widened head portion at the forward end of said handle lever, said head portion having at each of two sides of its longitudinal axis a downwardly extending flange and a forwardly extending cap and lid edge engaging ledge, said two flanges being substantially at right angles to each other, a somewhat V-shaped primary fulcrum depending ridge with its apex extending toward the apex between said flanges, and a secondary fulcrum area in said head portion along its longitudinal axis and spaced from said primary fulcrum.

U.S. Pat. No. 6,604,903 to Osborne et al. purports to disclose an automated safety cap removal mechanism for an automated medication preparation system. The mechanism includes an automated gripping device for securely holding and transporting a vial containing the medication to and from a first station and a cap removal device for removing a safety cap of the vial in a just-in-time for use manner. The cap removal device being located at the first station. By providing a just-in-time for use safety cap removal mechanism, the labor intensive task of removing safety caps can be incorporated into an automated medication preparation system.

### SUMMARY

In a first aspect, some embodiments of the invention provide a portable lifting apparatus for removing a protective seal from a medicine vial, comprising a gripping portion; and a lifting portion secured to the gripping portion and extending along a lifting portion longitudinal axis between a lifting portion forward end and a lifting portion rearward end, the lifting portion including a wedge portion having a pair of arm members laterally spaced about the lifting portion longitudinal axis to provide an inner space between, the pair of arm members extending apart at an acute angle and with an arm spacing between, the arm spacing increasing towards the lifting portion forward end, each arm member having an arm inward face facing the inner space, each arm inward face including an upwardly directed arm prying surface, and a backing portion defining a downwardly directed support surface extending over each of the pair of arm prying surfaces, and spaced from each of the pair of arm prying surfaces by a clearance distance.

In some embodiments, the first and second arm members are each linear.

In some embodiments, the acute angle is less than 40 degrees.

In some embodiments, the acute angle is 30 degrees.

In some embodiments, the clearance distance between the downwardly directed support surface and each upwardly directed arm prying surface of the pair of arm members is the same for each upwardly directed arm prying surface.

In some embodiments, the clearance distance is between 0.15 inches and 0.2 inches.

In some embodiments, the clearance distance is 0.17 inches.

In some embodiments, the gripping portion has a gripping portion forward end, a gripping portion rearward end, and a gripping portion longitudinal axis, wherein the gripping portion forward end is secured to the lifting portion rearward end and the gripping portion longitudinal axis is parallel with the lifting portion longitudinal axis.

In some embodiments, the gripping portion forms an elongated lever handle extending along the gripping portion longitudinal axis.

In some embodiments, each of the pair of arm inward faces includes an arm inwardly directed surface below the upwardly directed arm prying surface, each arm inwardly directed surface being beveled and having an arm inwardly directed surface upper edge extending further into the inner space than an arm inwardly directed surface lower edge.

In some embodiments, the gripping portion includes an aperture therethrough.

In some embodiments, each of the prying surfaces is smooth and planar.

In some embodiments, the support surface is smooth and planar.

In some embodiments, the rearward ends of the pair of arm members are joined by a curved elbow portion, the curved elbow portion having an elbow inward face facing the inner space, the elbow inner face including an upwardly directed elbow prying surface coplanar with each of the pair of arm prying surfaces, the downwardly directed support surface extending over the upwardly directed elbow prying surface and spaced therefrom by the clearance distance.

In some embodiments, the elbow inward face includes an elbow inwardly directed surface below the upwardly directed elbow prying surface, the elbow inwardly directed surface being beveled and having an elbow inwardly directed surface upper edge extending further into the inner space than an elbow inwardly directed surface lower edge.

In a second aspect, some embodiments of the invention provide a method of removing a protective seal from a medicine vial, comprising inserting a protective seal that is secured to a cap of a medicine vial into an open space between a pair of linear arm members of a lifting portion of a portable lifting apparatus, each of the pair of linear arm members having an inward face facing the open space and including an upwardly directed arm prying surface forming a boundary of the open space; positioning the protective seal within the open space on each of the pair of upwardly directed arm prying surfaces; lifting, by raising or lowering a gripping portion of the portable lifting apparatus, a first end of the lifting portion relative to the medicine vial to pry the protective seal away from the cap.

In some embodiments, the first end is a forward end and the gripping portion is an elongated lever handle secured to a rearward end of the lifting portion, wherein lifting the forward end of the lifting portion includes lowering the elongated lever handle secured to the rearward end of the lifting portion.

In some embodiments, the pair of linear arm members are spaced about a longitudinal axis of the lifting portion, the pair of linear arm members extending apparat at an acute angle and separated by an arm spacing that is greater at a forward end of the lifting portion and lesser at a rearward end of the lifting portion, wherein positioning the protective seal within the open space on each of the pair of upwardly directed arm prying surfaces includes advancing the lifting portion along the longitudinal axis while the protective seal is within the open space.

In some embodiments, the acute angle is less than 40 degrees.

In some embodiments, the portable lifting apparatus includes a backing portion forming a downwardly directed backing surface extending over each of the pair of arm prying surfaces and spaced from each of the pair of arm prying surfaces by a clearance distance, and wherein lifting a first end of the lifting portion relative to the medicine vial to pry the protective seal away from the cap includes transporting the protective seal to a disposal container while retained within the open space between the downwardly directed backing surface and the pair of upwardly directed arm prying surfaces and lowering the forward end of the lifting portion towards the disposal container to dispense the protective seal.

### BRIEF DESCRIPTION OF THE DRAWINGS

The drawings included herewith are for illustrating various examples of systems, methods, and apparatus of the present specification. In the drawings:

FIG. 1 is a perspective view of a medicine vial;

FIG. 2 is a cross sectional view of a portion of the medicine vial of FIG. 1, taken along line 2-2 of FIG. 1;

FIG. 3 is a perspective view of a first portable lifting apparatus, in accordance with an embodiment;

FIG. 4 is a bottom view of the portable lifting apparatus of FIG. 3, with internal structural details shown in dotted lines;

FIG. 5 is a side view of the portable lifting apparatus of FIG. 3, with internal structural details shown in dotted lines;

FIG. 6 is a cross sectional view of the portable lifting apparatus of FIG. 3, taken along line 6-6 of FIG. 4;

FIG. 7 is a perspective view of a second portable lifting apparatus, in accordance with an embodiment;

FIG. 8 is a bottom view of the portable lifting apparatus of FIG. 7;

FIG. 9 is a side view of the portable lifting apparatus of FIG. 7, with internal structural details shown in dotted lines;

FIG. 10 is a cross sectional view of the portable lifting apparatus of FIG. 7, taken along line 10-10 of FIG. 8;

FIG. 11 is a is a perspective view of a third portable lifting apparatus, in accordance with an embodiment;

FIG. 12 is a bottom view of the portable lifting apparatus of FIG. 11, with internal structural details shown in dotted lines;

FIG. 13 is a side view of the portable lifting apparatus of FIG. 11, with internal structural details shown in dotted lines

FIG. 14 is a front view of the portable lifting apparatus of FIG. 11, with internal structural details shown in dotted lines; and

FIG. 15 is a cross sectional view of the portable lifting apparatus of FIG. 11, taken along line 15-15 of FIG. 12.

### DETAILED DESCRIPTION

Various apparatuses or processes will be described below to provide an example of an embodiment of each claimed invention. No example described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim, or dedicate to the public any such invention by its disclosure in this document.

In accordance with an aspect of the present disclosure, which may be used alone or in combination with any other aspect(s), a portable lifting apparatus may be a hand held device for manual use in lifting a closure from a container. In some examples, a portable lifting apparatus is a shaped for use in lifting a protective seal from a medicine vial to expose a punctureable closure of the medicine vial. In some examples, a portable lifting apparatus helps alleviate strain injury incurred by opening protective seals. In some examples, a portable lifting apparatus is shaped for use where needed, such as at a bed side or at a medicine storage area.

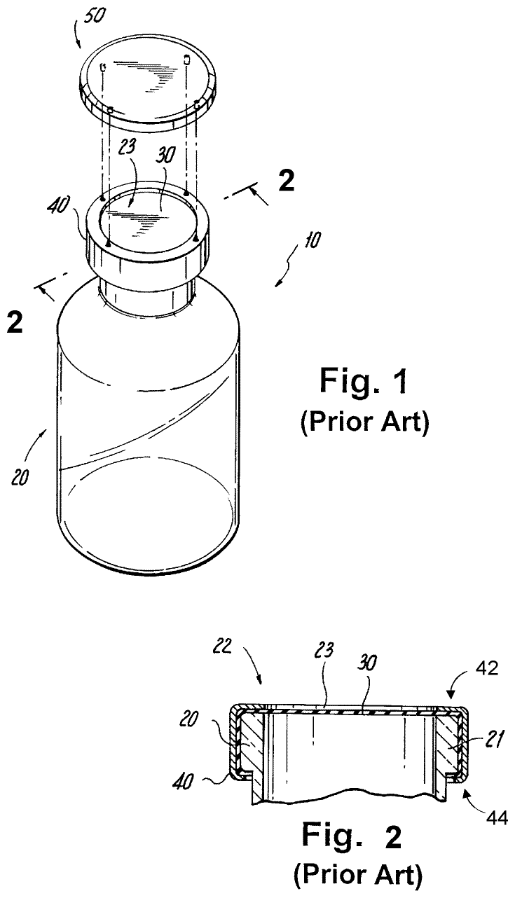

Referring to FIG. 1, an example of a prior art medicine vial 10 is depicted. Medicine vial 10 is described in U.S. Pat. No. 6,604,903. Medicine vial 10 is formed of a body 20 and sealed with a membrane 30 across the open end 22 of the body 20. In some examples, the body 20 is a glass body and the membrane is a rubber material that can be easily stretched across the open end 22 while still providing the necessary seal.

Referring now to FIG. 2, in the illustrated example the membrane 30 is securely held in place across the open end 22 by a retainer ring 40 that is itself securely attached to the body 20. The retainer ring 40 circumferentially surrounds a neck 21 formed at the open end 22 and includes an upper section 42 that seats against an upper surface of the membrane 30 and a lower section 44 that engages the body 20 underneath the neck 21. The retainer ring 40 is open in a middle section 23 thereof such that when the retainer ring 40 is securely attached to the body 20 the retainer ring 40 holds the stretched membrane 30 in place with the membrane 30 being visible in the open middle section of the retainer ring 40.

Referring again to FIG. 1, in some examples a safety cap or protective seal 50 is securely attached to the vial 10 to cover the exposed membrane 30 and further seal the open end 22 of the vial body 20. The protective seal 50 is a solid member that extends completely across the exposed portion of the membrane 30. In some examples, a protective seal 50 is formed of a light, disposable material such as plastic. In some examples, a protective seal 50 is attached at the end 22 in a tamper proof manner so that when the protective seal 50 is removed it is difficult to reattach the protective seal 50.

In accordance with an aspect of the present disclosure, which may be used alone or in combination with any other aspect(s), a portable lifting apparatus includes a gripping portion and includes a lifting portion having a pair of arm members laterally spaced and extending apart at an acute angle.

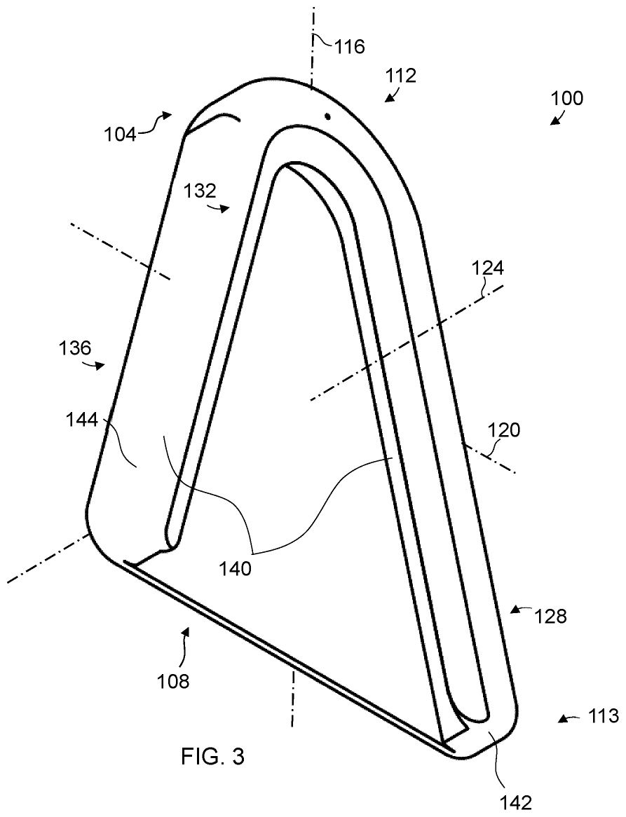

Referring to FIG. 3, an example of a portable lifting apparatus 100 is depicted. Illustrated portable lifting apparatus 100 includes a gripping portion 104 and a lifting portion 108. In the illustrated example, gripping portion 104 includes a rearward end 112 of portable lifting apparatus 100. The illustrated lifting portion 108 has a lifting portion longitudinal axis 116. The illustrated lifting portion 108 also has a lifting portion transverse axis 120 and a lifting portion vertical axis 124.

Illustrated lifting portion 108 extends along the lifting portion longitudinal axis 116 and has a lifting portion forward end 128 and a lifting portion rearward end 132. The example lifting portion 108 includes a wedge portion 136 having a pair of arm members 140 including first arm member 142 and second arm member 144. In some examples, a wedge facilitates use with a variety of cap or seal sizes. In some examples, a wedge facilitates easy insertion of a cap or seal into a space formed by the portable lifting apparatus above prying surfaces of the portable lifting apparatus, as described further below.

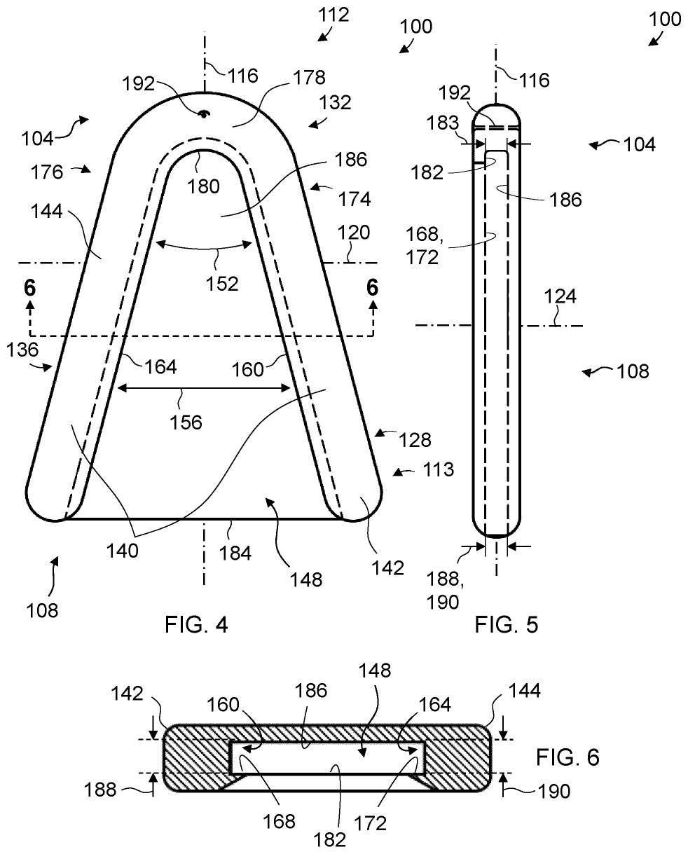

Referring now to FIGS. 4 to 6, the illustrated example first and second arm members 142, 144 are linear arm members. The first and second arm members 142, 144 are laterally spaced about the lifting portion longitudinal axis 116 to provide an inner space 148 between. In some examples, a wide angle between arm members does not allow sufficient surface area and/or sufficiently opposed edges of a cap or seal to be positioned on the prying surfaces. In some examples, arm members 142, 144 extend apart at an acute angle 152, with an arm spacing 156 increasing towards the lifting portion forward end 128. As in the illustrated example, the acute angle 152 may be less than 40 degrees to facilitate use with common medicine vial cap diameters (e.g. caps with diameters of ⅛ of an inch to 2 inches). In the illustrated example, the acute angle is about 30 degrees. In some examples, an acute angle facilitates positioning a sufficient surface area of a cap or seal on prying surfaces formed by the lifting apparatus 100 to allow the cap or seal to be pried off of a vial. In some examples, an acute angle facilitates positioning sufficiently opposed edges of a cap or seal upon the prying surfaces to allow the cap or seal to be pried off of a vial.

First and second linear arm members 142, 144 each have an arm inward face 160, 164 facing the inner space 148. Each arm inward face 160, 164 includes an upwardly directed arm prying surface 168, 172 (FIG. 6). In some examples, the arm prying surfaces 168, 172 are shaped to have a protective seal of a medicine vial seated thereon. In some examples, the arm prying surfaces 168, 172 are shaped to have a protective seal of a medicine vial slide thereover. In some examples, the arm prying surfaces 168, 172 are each planar surfaces. In some examples, the arm prying surfaces 168, 172 are each smooth, planar surfaces. In some examples, the upwardly directed arm prying surfaces 168, 172 are coplanar.

In some examples, removing a protective seal that is secured to a cap of a medicine vial includes inserting the protective seal into an open space 148 between arm members. In some examples, removing a protective seal secured to a cap of a medicine vial includes inserting the protective seal into an open space between a pair of linear arm members of a lifting portion of a portable lifting apparatus, each of the pair of linear arm members having an inward face facing the open space and including an upwardly directed arm prying surface forming a boundary of the open space. For example, removing the protective seal 50 when the protective seal 50 is secured to the vial 10 may include inserting the protective seal 50 between the arm members 142, 144 of the lifting apparatus 100.

In some examples, removing a protective seal that is secured to a cap of a medicine vial includes positioning the protective seal within the open space on each of a pair of upwardly directed arm prying surfaces. For example, removing the protective seal 50 when the protective seal 50 is secured to the vial 10 may include positioning the protective seal 50 within the open space 148 on each of the pair of upwardly directed arm prying surfaces 168, 172.

In some examples, positioning the protective seal within the open space on each of the pair of upwardly directed arm prying surfaces includes advancing the lifting portion along the longitudinal axis while the protective seal is within the open space. For example, removing the protective seal 50 when the protective seal 50 is secured to the vial 10 may include advancing the lifting portion 108 along the longitudinal axis 116 while the protective seal 50 is within the open space 148. In some examples, advancing the lifting portion 108 along the longitudinal axis 116 while the protective seal 50 is within the open space 148 moves the protective seal 50 further to a rearward end 112 of portable lifting apparatus 100 within the open space 148, where a spacing 156 between arm members 142, 144 is narrower. In some examples, moving a protective seal 50 rearward within an open space, such as open space 148, facilitates seating the protective seal 50 on each of the pair of upwardly directed arm prying surfaces 168, 172.

In some examples, removing a protective seal that is secured to a cap of a medicine vial includes lifting, by raising or lowering a gripping portion of the portable lifting apparatus, a first end of the lifting portion relative to the medicine vial to pry the protective seal away from the cap. For example, removing the protective seal 50 when the protective seal 50 is secured to the vial 10 may include lifting a first end of the lifting portion 108, which may be the forward end or the rearward end, relative to the medicine vial 10 by raising or lowering the gripping portion 104.

In some examples, the first and second arm members 142, 144 are joined at rearward ends 174, 176 of the first and second arm members 142, 144 by a curved elbow portion 178. In some examples, an elbow portion 178 also includes a prying surface. In some examples, an elbow portion 178 is used to pry a small-diameter protective seal where a diameter of the small-diameter protective seal is less than the spacing 156 between the arms at the narrowest point. Illustrated example elbow portion 178 has an elbow inward face 180 facing the inner space 148. The illustrated elbow inner face 180 includes an upwardly directed elbow prying surface 182. In some examples, the elbow prying surface 182 is shaped to have a protective seal of a medicine vial seated thereon. In some examples, the elbow prying surface 182 is shaped to have a protective seal of a medicine vial slide thereover. In some examples, the elbow prying surface 182 is a planar surface. In some examples, the elbow prying surface 182 is a smooth, planar surface. In some examples, the elbow prying surface 182 is coplanar with the upwardly directed arm prying surfaces 168, 172.

The illustrated example lifting portion 108 also includes a backing portion 184. Backing portion 184 defines a downwardly directed support surface 186 extending over each of the pair of arm prying surfaces 168, 172. In some examples, a backing portion supports a cap or seal to keep it from buckling when being pried from a container.

In some examples, the downwardly directed support surface 186 is spaced from the first arm prying surface 168 by a first clearance distance 188 and from the second arm prying surface 172 by a second clearance distance 190. In the illustrated example, the first and second clearance distances 188, 190 are the same magnitude. In the illustrated example, the clearance distances 188, 190 are each between 0.1 and 0.5 inches, 0.1 and 0.3 inches, or 0.15 inches and 0.2 inches. In the illustrated example, the clearance distances 188, 190 are each about 0.17 inches. In some examples, a spacing similar to the thickness of a cap or seal facilitates removal of the cap or seal without the cap or seal buckling during a prying operation.

In some examples, downwardly directed support surface 186 extends over elbow prying surface 182. In some examples, the downwardly directed support surface 186 is spaced from the elbow prying surface 182 by an elbow clearance distance 183. In some examples, the elbow clearance distance 183 is between 0.15 inches and 0.2 inches. In the illustrated example, the elbow clearance distance 183 is about 0.17 inches.

In some examples, the downwardly directed support surface 186 is shaped to have a protective seal of a medicine vial slide thereover. In some examples, the downwardly directed support surface 186 is a planar surface. In some examples, the downwardly directed support surface 186 is a smooth, planar surface. In the illustrated example, the downwardly directed support surface 186 is a continuous, planar surface bounding an upper end of the open space 148.

In some examples, a protective seal may be retained in a lifting apparatus after being removed from a medicine vial. In some examples, a protective seal may be transported to a disposal container while retained within the open space between the downwardly directed backing surface and the pair of upwardly directed arm prying surfaces. For example, removing the protective seal 50 when the protective seal 50 is secured to the vial 10 may include retaining the protective seal 50 within the open space 148 between the downwardly directed backing surface 186 and the pair of upwardly directed arm prying surfaces 168, 172.

In some examples, retaining a protective seal within an open space includes holding the portable lifting apparatus with the forward end above a rearward end. In some examples, a forward end is below a rearward end but friction holds the protective seal within the open space. In some examples, retaining a protective seal within an open space includes holding the portable lifting apparatus with the longitudinal axis at less than 45 degrees from horizontal, with a forward end lower than a rearward end. In some examples, retaining a protective seal within an open space includes holding the portable lifting apparatus with the longitudinal axis at less than 10 degrees from horizontal, with a forward end lower than a rearward end. For example, the protective seal 50 may be retained within the open space 148 between the downwardly directed backing surface 186 and the pair of upwardly directed arm prying surfaces 168, 172 with the forward end 113 of the portable lifting apparatus 100 above the rearward end 112. In another example, the protective seal 50 may be retained within the open space 148 between the downwardly directed backing surface 186 and the pair of upwardly directed arm prying surfaces 168, 172 with the forward end 113 below the rearward end 112 with the longitudinal axis 116 at less than 45 degrees from horizontal. In another example, the protective seal 50 may be retained within the open space 148 between the downwardly directed backing surface 186 and the pair of upwardly directed arm prying surfaces 168, 172 with the forward end 113 below the rearward end 112 with the longitudinal axis 116 at less than 10 degrees from horizontal.

In some examples, a user can lower the forward end of the lifting portion towards the disposal container to dispense the protective seal retained within the open space between the downwardly directed backing surface and the pair of upwardly directed arm prying surfaces. For example, the portable lifting apparatus 100 with the protective seal 50 retained within the open space 148 between the downwardly directed backing surface 186 and the pair of upwardly directed arm prying surfaces 168, 172 may be lowered with the forward end 113 below the rearward end 112. In another example, the portable lifting apparatus 100 with the protective seal 50 retained within the open space 148 between the downwardly directed backing surface 186 and the pair of upwardly directed arm prying surfaces 168, 172 may be lowered with the forward end 113 below the rearward end 112 and the longitudinal axis 116 more than 10 degrees from horizontal. In another example, the portable lifting apparatus 100 with the protective seal retained within the open space 148 between the downwardly directed backing surface 186 and the pair of upwardly directed arm prying surfaces 168, 172 may be lowered with the forward end 113 below the rearward end 112 and the longitudinal axis 116 more than degrees from horizontal.

In some examples, the portable lifting apparatus 100 may be carried with a user when not in use. In the illustrated example, the portable lifting apparatus 100 includes an aperture 192 therethrough. Aperture 192 is provided in a rearward end 112 of portable lifting apparatus 100. In some examples, a flexible cord may be passed through aperture 192 and formed into a loop for use in hanging the portable lifting apparatus 100. In some examples, a loop of flexible cord passed through aperture 192 is used to hang a portable lifting apparatus 100 from a belt of a user. In some examples, a loop of flexible cord passed through aperture 192 is used to hang the portable lifting apparatus from an environmental hook near a likely use location such as a medicine vial storage station or a bed.

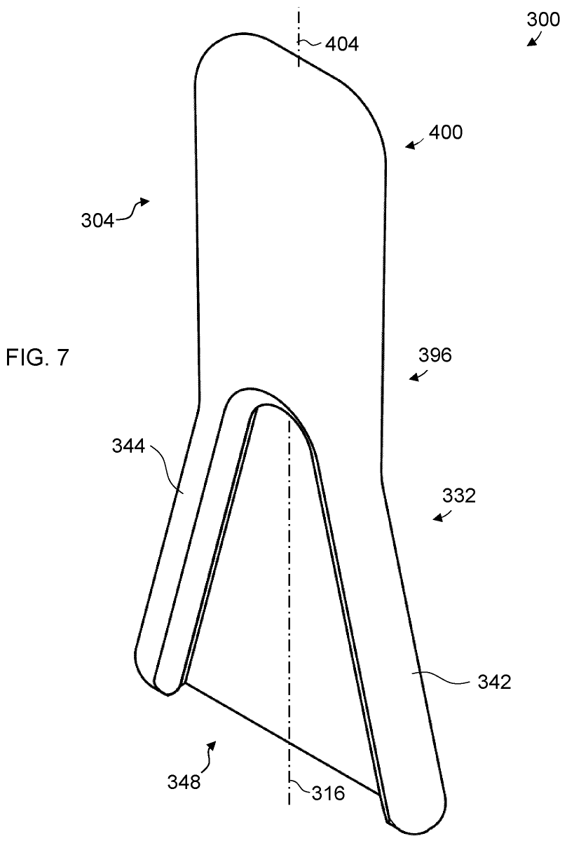

Referring now to FIG. 7, another example of a portable lifting apparatus 300 is illustrated. Portable lifting apparatus 300 is similar in many respects to the portable lifting apparatus 100 of FIGS. 3 and 4, and like features are identified by like reference characters, incremented by 200.

The portable lifting apparatus 300 also includes a gripping portion 304 and a lifting portion 308. In the example illustrated, gripping portion 304 has a gripping portion forward end 396, a gripping portion rearward end 400, and gripping portion longitudinal axis 404. The illustrated gripping portion forward end 396 is secured to the lifting portion rearward end 332. In the illustrated example, the gripping portion longitudinal axis 404 is parallel with the lifting portion longitudinal axis 316. In the illustrated example, the gripping portion longitudinal axis 404 is coaxial with the lifting portion longitudinal axis 316.

In some examples, a gripping portion is an elongated lever handle, the elongated lever handle may be secured to a rearward end of the lifting portion and may be used to lift a forward end or a rearward end of the lifting portion by lowering or raising, respectively, the elongated lever portion relative the medicine vial. In some examples, an elongated lever handle may be secured to a rearward end of a lifting portion and used to lift a forward end of the lifting portion by lowering the elongated lever portion relative the medicine vial. For example, removing the protective seal 50 when the protective seal 50 is secured to the vial 10 may include lifting a forward end of the lifting portion 308 relative the medicine vial 10 by lowering the gripping portion rearward end 400 relative the medicine vial 10.

In some examples, a gripping portion is a lever handle to assist a user in lifting a portion of a protective cap using a lifting portion of a portable lifting apparatus. In the illustrated example, the gripping portion 304 forms an elongated lever handle extending along the gripping portion longitudinal axis 404.

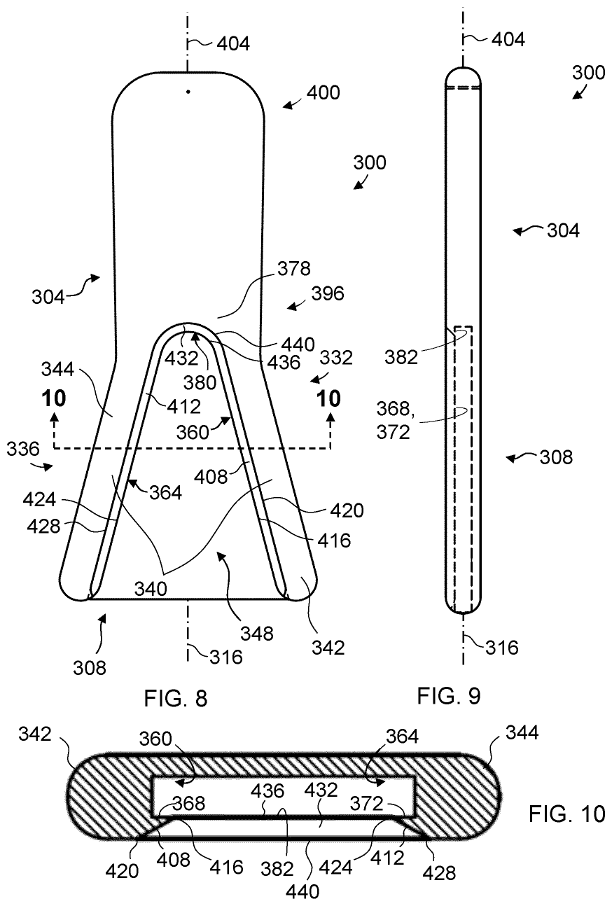

Referring now to FIGS. 8 to 10, lifting portion 308 includes a wedge portion 336 having a pair of arm members 340 including first arm member 342 and second arm member 344. In the illustrated example, first arm member 342 and second arm member 344 are each linear arm members.

In some examples, a wedge portion may be shaped to be inserted under a protective seal on a medicine vial. In some examples, a wedge portion may be shaped to have a protective seal of a medicine vial seated on one or more prying surface of the wedge portion. In the illustrated example, first and second linear arm members 342, 344 each have an arm inward face 360, 364 facing the inner space 348. Each arm inward face 360, 364 includes an upwardly directed arm prying surface 368, 372. In the illustrated example, each arm inward face 360, 365 also includes an arm inwardly directed surface 408, 412 below the upwardly directed arm prying surface 368, 372. In the illustrated example, each arm inwardly directed surface 408, 412 is beveled. In some examples, a beveled surface facilitates use with a protective cap or seal that is flush mounted on a medicine vial closure. In some examples, a beveled surface facilitates inserting a lifting portion between a flush mounted cap or seal and a medicine vial closure.

In the illustrated example, the first arm inwardly directed surface 408 has a first arm inwardly directed surface upper edge 416 extending further into the inner space 348 than a first arm inwardly directed surface lower edge 420. In the illustrated example, the second arm inwardly directed surface 412 has a second arm inwardly directed surface upper edge 424 extending further into the inner space 348 than a second arm inwardly directed surface lower edge 428.

In some examples, the arm inwardly directed surfaces 408, 412 are shaped to have an upper edge of a medicine vial or associated covering slide thereover. In some examples, the arm inwardly directed surfaces 408, 412 are each planar surfaces. In some examples, the arm inwardly directed surfaces 408, 412 are each smooth, planar surfaces.

In the illustrated example, the elbow portion 378 has an elbow inner face 380 facing the inner space 348. Elbow inner face 380 includes an upwardly directed elbow prying surface 382. In the illustrated example, elbow inner face 380 also includes an elbow inwardly directed surface 432 below the upwardly directed elbow prying surface 382. In the illustrated example, the elbow inwardly directed surface 432 is beveled. In the illustrated example, the elbow inwardly directed surface 432 has an elbow inwardly directed surface upper edge 436 extending further into the inner space 348 than an elbow inwardly directed surface lower edge 440.

In some examples, the elbow inwardly directed surface 432 is shaped to have an upper edge of a medicine vial or associated covering slide thereover. In some examples, the elbow inwardly directed surface 432 is a planar surface. In some examples, the elbow inwardly directed surface 432 is a smooth, planar surface. In some examples, the elbow inwardly directed surface 432 is a smooth continuation of each of the arm inwardly directed surfaces 408, 412.

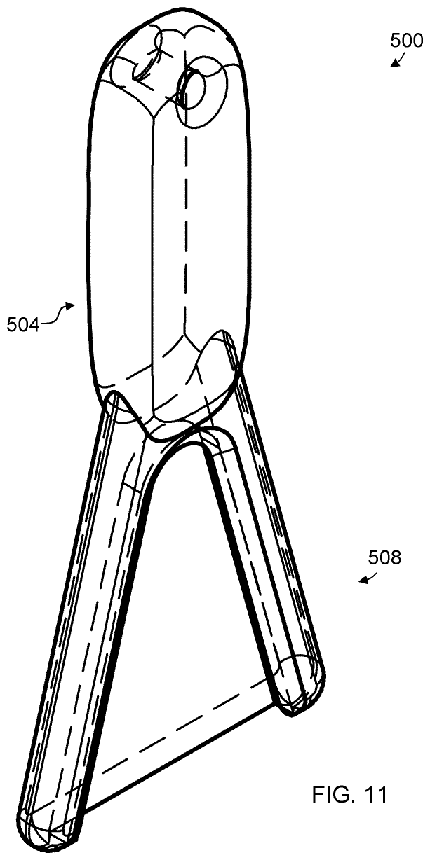

Referring now to FIG. 11, another example of a portable lifting apparatus 500 is illustrated. Portable lifting apparatus 500 is similar in many respects to the portable lifting apparatus 100 of FIGS. 3 and 4, and like features are identified by like reference characters, incremented by 400.

The portable lifting apparatus 500 also includes a gripping portion 504 and a lifting portion 508. A forward end of the gripping portion 504 is secured to a rearward end of the lifting portion. In some examples, the gripping portion is shaped for comfortable long-term gripping. The gripping portion may be shaped to have a comfortable hand-feel. For example, the gripping portion may have a height that is greater than a height of the lifting portion and/or similar in size to the width of the gripping portion. The gripping portion may be shaped such that corners of a transverse and vertical cross section are rounded.

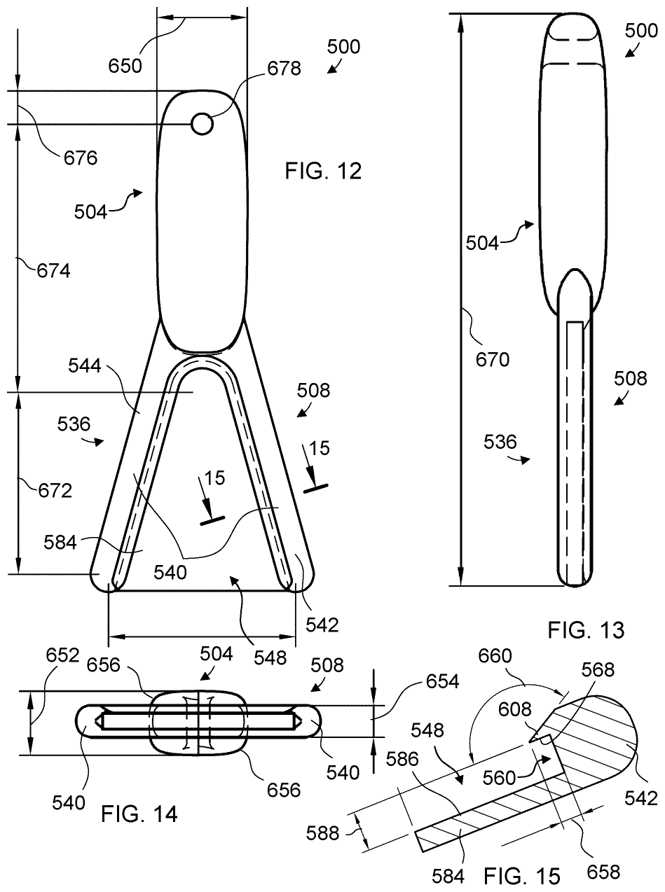

Referring now to FIGS. 12 to 15, the illustrated example gripping portion 504 has a width 650 and a height 652. The width 650 may be between 0.1 and 3 inches, 0.5 and 2 inches, between 0.75 and 1.5 inches, between, 1 and 1.2 inches, or about 1.1 inches. The height 652 may be between 0.1 and 3 inches, 0.5 and 1.5 inches, 0.5 and 1 inches, or about 0.7 inches. In the illustrated example, the width 650 of the gripping portion 504 is greater than the height 652 of the gripping portion 504 by less than 150%, less than 100%, less than 90%, less than 70%, or less than 60% of the height 652 of gripping portion 504.

The shape of the gripping portion 504 may also or alternatively be related to the length of the device 500. The device 500 may have a length 670 of between 1 and between 3 and 10, between 4 and 8, or about 6 inches. The length 672 of the wedge portion 536 of the lifting portion 508 may be between 0.5 and 5, between 1 and 3, or about 2.2 inches. A length 674 of the rear portion of the device 500 between the wedge portion 536 and a hanging aperture 678 may be between 1 and 6, between 2 and 5, between 2.5 and 4, or about 3.2 inches. A length 676 of the rear portion of the device 500 rear of the hanging aperture 678 may be between 0.1 and 1, between 0.2 and 0.8, or about 0.4 inches.

The illustrated lifting portion 508 has a height 654, and the height 654 may be between 0.1 and 2 inches, 0.25 and 1 inches, 0.3 and 0.5 inches, or about 0.4 inches. In the illustrated example, the height 650 of the gripping portion 504 is larger than the height 654 of the lifting portion 508. As illustrated in FIG. 14, the gripping portion 504 is shaped such that corners 656 of a transverse and vertical cross section are rounded.

The example lifting portion 508 includes a wedge portion 536 having a pair of arm members 540. In the illustrated example, the pair of arm members 540 includes first and second linear arm members 542, 544. First and second linear arm members 542, 544 are similar. First arm member 542 has an arm inward face 560 facing the inner space 548. The arm inward face 560 includes an upwardly directed arm prying surface 568. The arm prying surface 568 may extend into the inner space 548 by an extension distance 658 of less than 0.5, less than 0.25, between 0.05 and 0.25, between 0.08 and 0.12, or about 0.1 inches. In the illustrated example, the arm inward face 560 also includes an arm inwardly directed surface 608 below the upwardly directed arm prying surface 568. In the illustrated example, the arm inwardly directed surface 608 is beveled. The inwardly directed surface 608 may extend at an angle 660 of between 100 and 200 degrees, between 125 and 175 degrees, or about 150 degrees relative to the plane of the backing plate 584. In some examples, a beveled surface facilitates use with a protective cap or seal that is flush mounted on a medicine vial closure. In some examples, a beveled surface facilitates inserting a lifting portion between a flush mounted cap or seal and a medicine vial closure.

The wedge portion 536 also includes a backing portion 584. Backing portion 584 defines a downwardly directed support surface 586 extending over each of the arm prying surfaces. The downwardly directed support surface 586 is spaced from the first arm prying surface 568 by a first clearance distance 588. In the illustrated example, the first clearance distance 588 is between 0.1 and 0.5 inches, 0.1 and 0.3 inches, or 0.15 inches and 0.2 inches. In the illustrated example, the clearance distance 588 is about 0.2 inches.

The present invention has been described here by way of example only. Various modification and variations may be made to these exemplary embodiments without departing from the scope of the invention, which is limited only by the appended claims.

1. A portable lifting apparatus for removing a protective seal from a medicine vial, comprising:
a. a gripping portion; and
b. a lifting portion secured to the gripping portion and extending along a lifting portion longitudinal axis between a lifting portion forward end and a lifting portion rearward end, the lifting portion including:
i. a wedge portion having a pair of arm members laterally spaced about the lifting portion longitudinal axis to provide an inner space between, the pair of arm members extending apart at an acute angle and with an arm spacing between, the arm spacing increasing towards the lifting portion forward end, each arm member having an arm inward face facing the inner space, each arm inward face including an upwardly directed arm prying surface, and
ii. a backing portion defining a downwardly directed support surface extending over each of the pair of arm prying surfaces, and spaced from each of the pair of arm prying surfaces by a clearance distance.

2. The portable lifting apparatus of claim 1, wherein the first and second arm members are each linear.

3. The portable lifting apparatus of claim 2, wherein the acute angle is less than 40 degrees.

4. The portable lifting apparatus of claim 3, wherein the acute angle is 30 degrees.

5. The portable lifting apparatus of claim 2, wherein the clearance distance between the downwardly directed support surface and each upwardly directed arm prying surface of the pair of arm members is the same for each upwardly directed arm prying surface.

6. The portable lifting apparatus of claim 5, wherein the clearance distance is between 0.15 inches and 0.2 inches.

7. The portable lifting apparatus of claim 5, wherein the clearance distance is 0.17 inches.

8. The portable lifting apparatus of claim 2, wherein the gripping portion has a gripping portion forward end, a gripping portion rearward end, and a gripping portion longitudinal axis, wherein the gripping portion forward end is secured to the lifting portion rearward end and the gripping portion longitudinal axis is parallel with the lifting portion longitudinal axis.

9. The portable lifting apparatus of claim 2, wherein the gripping portion forms an elongated lever handle extending along the gripping portion longitudinal axis.

10. The portable lifting apparatus of claim 2, wherein each of the pair of arm inward faces includes an arm inwardly directed surface below the upwardly directed arm prying surface, each arm inwardly directed surface being beveled and having an arm inwardly directed surface upper edge extending further into the inner space than an arm inwardly directed surface lower edge.

11. The portable lifting apparatus of claim 2, wherein the gripping portion includes an aperture therethrough.

12. The portable lifting apparatus of claim 2, wherein each of the prying surfaces is smooth and planar.

13. The portable lifting apparatus of claim 12, wherein the support surface is smooth and planar.

14. The portable lifting apparatus of claim 2, wherein the rearward ends of the pair of arm members are joined by a curved elbow portion, the curved elbow portion having an elbow inward face facing the inner space, the elbow inner face including an upwardly directed elbow prying surface coplanar with each of the pair of arm prying surfaces, the downwardly directed support surface extending over the upwardly directed elbow prying surface and spaced therefrom by the clearance distance.

15. The portable lifting apparatus of claim 14, wherein the elbow inward face includes an elbow inwardly directed surface below the upwardly directed elbow prying surface, the elbow inwardly directed surface being beveled and having an elbow inwardly directed surface upper edge extending further into the inner space than an elbow inwardly directed surface lower edge.

16. A method of removing a protective seal from a medicine vial, comprising:
a. inserting a protective seal that is secured to a cap of a medicine vial into an open space between a pair of linear arm members of a lifting portion of a portable lifting apparatus, each of the pair of linear arm members having an inward face facing the open space and including an upwardly directed arm prying surface forming a boundary of the open space;
b. positioning the protective seal within the open space on each of the pair of upwardly directed arm prying surfaces;
c. lifting, by raising or lowering a gripping portion of the portable lifting apparatus, a first end of the lifting portion relative to the medicine vial to pry the protective seal away from the cap.

17. The method of claim 16, wherein the first end is a forward end and the gripping portion is an elongated lever handle secured to a rearward end of the lifting portion, wherein lifting the forward end of the lifting portion includes lowering the elongated lever handle secured to the rearward end of the lifting portion.

18. The method of claim 16, wherein the pair of linear arm members are spaced about a longitudinal axis of the lifting portion, the pair of linear arm members extending apparat at an acute angle and separated by an arm spacing that is greater at a forward end of the lifting portion and lesser at a rearward end of the lifting portion, wherein positioning the protective seal within the open space on each of the pair of upwardly directed arm prying surfaces includes advancing the lifting portion along the longitudinal axis while the protective seal is within the open space.

19. The method of claim 18, wherein the acute angle is less than 40 degrees.

20. The method of claim 18, wherein the portable lifting apparatus includes a backing portion forming a downwardly directed backing surface extending over each of the pair of arm prying surfaces and spaced from each of the pair of arm prying surfaces by a clearance distance, and wherein lifting a first end of the lifting portion relative to the medicine vial to pry the protective seal away from the cap includes transporting the protective seal to a disposal container while retained within the open space between the downwardly directed backing surface and the pair of upwardly directed arm prying surfaces and lowering the forward end of the lifting portion towards the disposal container to dispense the protective seal.
